(19) United States
(12) Patent Application Publication
(10) Pub. No.: US 2002/0053167 A1
(43) Pub. Date: May 9, 2002

(54) Apparatus for rail wagons

(76) Inventor: Ian Hunter, Victoria (AU)

Correspondence Address: JAMES RAY & ASSOCIATES, 2640 PITCAIRN ROAD, MONROEVILLE, PA, 15146, US

(21) Appl. No.: 09/813,188

(22) Filed: Mar. 20, 2001

(30) Foreign Application Priority Data
Nov. 3, 2000 (AU) PR 1216

(51) Int. Cl. E05F 11/00

(52) U.S. Cl. 49/333

(57) ABSTRACT

An apparatus for securing a hinged lid which covers an opening in the top of a rail wagon when it is in a closed position. The apparatus includes a rod rotatably mounted to the top of the wagon along at least part of a free side of the lid opposite or adjacent a hinged side of the lid. An arm is mounted to such rod which bears on the lid and thereby secures the lid in such closed position. There is a rotation device for rotating the rod. The rotation device is operable to rotate the rod and thereby rotate the arm away from the lid so that the lid may be opened.

The present invention relates to apparatus and system for rail wagons. More specifically, the invention relates to: an apparatus for securing a hinged lid which covers an opening in a top of a rail wagon when in a closed position; an apparatus for moving a hinged lid from and to a closed position; an apparatus for opening a slidably mounted door located at a bottom of a rail wagon; and an automated system for opening a hinged lid and sliding door.

Rail wagons, such as wheat or grain wagons, have a series of openings in their top which allows produce such as wheat or grain to be poured into the top of the wagon in order to fill the wagon. Each opening is typically covered by a lid which needs to be opened to allow grain to be poured through the opening and closed to prevent spoiling of the grain or wheat due to exposure to the weather. The grain or wheat is typically discharged from the bottom of the wagon through an opening which can be covered or uncovered by a sliding door.

The lid is sometimes described as a hatch or top door but herein will be generically referred to as a lid.

Similarly, the sliding door is sometimes described as a bottom door or sliding hatch but herein will be generically referred to as a door.

In the past such lids and doors have been opened manually. Mishandling of the manual opening of the lids or doors has the potential to lead to serious consequences. The top of a wheat wagon is a significant distance from the ground and mishandling of the opening of the lid not only has the potential to lead to injury as a result of the lid striking the person opening it, but can also cause the person opening the lid to lose balance and fall from the rail wagon. Furthermore, the door of a rail wagon supports the weight of a large portion of wheat contained within the wagon and as a result in held firmly in a closed position due to frictional forces. Manually opening the door, therefore, requires an operator to exert a large physical effort which may cause injury such as spinal injury, particularly if repeated on numerous occasions. Obviously, manually operating the lid or door is a serious health and safety issue.

While some attempts have been made to address these issues they have not produced satisfactory solutions in that they have required overly expensive and complicated systems to be installed on the rail wagons. Further, no solution has been proposed which enables a lid to be opened more than 120°.

A further problem with rail wagons is that the lids are often poorly secured and the movement of air relative to the wagon can cause them to lift allowing water to enter the wagon and spoil the grain. Earlier attempts to seal the lids more securely required major modifications to be made to the wagons. This was unsatisfactory due to the cost involved. Further, where securing mechanisms have been provided they have had to be operated manually, again leading to the risks associated persons operating on the top of a wagon.

It is therefore an object of the present invention to provide an improved apparatus and system for opening the lid and/or door of a rail wagon.

Accordingly, a first aspect of the invention provides an apparatus for securing a hinged lid which covers an opening in the top of a rail wagon when in a closed position, said apparatus including;

a rod rotatably mounted to the top of the wagon along at least part of a free aide of said lid opposite or adjacent a hinged side of said lid;

an arm mounted to said rod, said arm bearing on said lid to secure said lid in said closed position; and

rotation means for rotating said rod, wherein said rotation means is operable to rotate said rod to thereby rotate said arm away from said lid whereafter said lid may be opened.

Herein, a “rod” may include a pipe or other generally cylindrical elongate member.

Herein, a “lid” may be understood to encompass a top door or a hatch.

Preferably, said rotation means is a rotation cylinder mounted to said wagon and having a piston mounted to said rod so that reciprocal motion of said piston causes rotation of said rod.

Preferably, said cylinder is an pneumatic cylinder.

Preferably, said apparatus further includes a lid opening cylinder having a lid opening cylinder piston connected to said lid for opening said lid.

Preferably, said lid opening cylinder piston is connected to said lid by means of a moon cam, whereby said lid may be rotated around said hinges more than 120° from said secured position.

Preferably, said apparatus includes a plurality of spaced apart arms mounted to said rod.

Preferably, said pneumatic cylinder is coupled to an air reservoir of said wagon.

Preferably, said arm has a notch on an underside thereof adapted to receive a protrusion carried by said lid when securing said lid in said closed position.

Preferably, said apparatus further includes locking means for locking said rod so as to prevent it from being rotated when said arm is securing said lid in said closed position.

Preferably, said locking means includes a locking lever which is prevented from moving by a locking piston of a locking cylinder in blocking engagement with said locking lever when in a locked position, whereby reciprocal movement of said locking piston moves said piston from said blocking position to a non-blocking position in which said lever and said rod are free to rotate.

In a second aspect, the invention provides apparatus for opening a hinged lid from a closed position in which said lid covers an opening in a top of a rail wagon, said apparatus including:

a cam attached to said lid, said cam having an cut-out section; and

an opening cylinder having a piston, the free end of the piston being mounted to the cam so that it can move within the cut-out section of said cam, the opening cylinder being operable to open said lid, during initial opening of the lid, the free end of the piston abutting the end of the cut-out section nearest the cylinder whereby operation of the cylinder pulls the lid up so that it rotates around the hinge until said lid reaches a point at which gravity causes further opening of said lid, whereafter said cut-out section of said cam allows said cam to move relative to said free end to a fully opened position.

Preferably, said cut-out section is shaped so that said lid can rotate more than 120° from the closed position.

Preferably, said cut-out section is arcuate.

Preferably, said cut-out section is shaped so that said lid can rotate more than 150° and even more preferably approximately 160°.

Preferably, said arcuate cut-out section has an arc length of greater than 50° and more preferably of approximately 70°.

Preferably, said opening cylinder is a pneumatic cylinder.

Preferably, said opening cylinder is coupled to an air reservoir of said wagon.

Preferably, two or more lids are connected, whereby said opening cylinder is operable to open two or more lids.

Preferably, said opening cylinder is also operably to return said lid to said closed position.

Preferably, the first and second aspects of the invention are combined.

According to a third aspect of the present invention there is provided an apparatus for opening a door slidably mounted to cover an opening at a bottom of a rail wagon when said door is in a closed position, the apparatus including,

an opening cylinder having a piston, the free end of the piston being connected to the door so that operation of the opening cylinder can slide the door from said closed position to an open position.

Herein, a “door” may be understood to encompass a sliding door or a bottom hatch.

Accordingly to a fourth aspect of the present invention there is provided an automatic system for opening a hinged lid and a slidable door from a closed position in which said hinged lid covers an opening in a top of a rail wagon and said door covers an opening located at a bottom of the rail wagon, said system including:

(a) a first apparatus having a first opening cylinder with a piston, the free end of the first piston being connected to said door; and

(b) a second apparatus including:

a cam attached to said lid, said cam having a cut-out section; and

an opening cylinder having a piston, the free end of the piston being mounted to the cam so that it can move within the cut out section of said cam; and

the system being characterised in that during initial opening of the lid, the free end of the piston abuts the end of the cut-out section nearest the opening cylinder such that operation of the cylinder pulls the lid up so that it rotates about a hinge until said lid reaches a point at which gravity causes further opening of said lid, whereafter said cut-out section of said cam allows said cam to move relative to said free end of the opening piston so that the lid moves to a fully opened position, and the system being further characterised in that said first and second opening cylinders are operable to open said door and lid respectively.

A preferred embodiment of the invention will now be described with reference to the accompanying drawings in which:

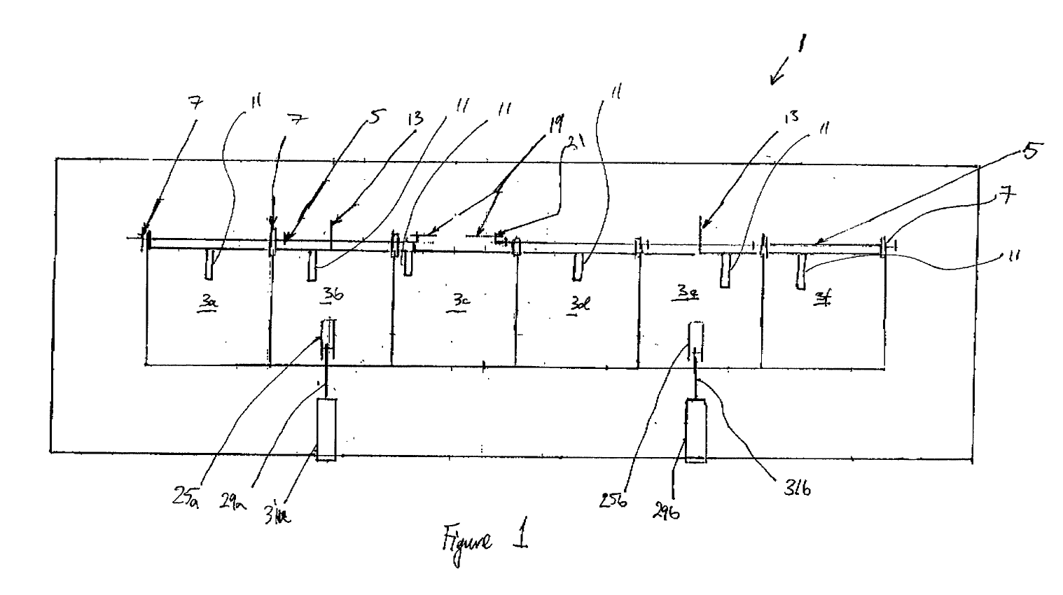

FIG. 1 is a top view of a rail wagon fitted with apparatus for securing a hinged lid and apparatus for opening a hinged lid;

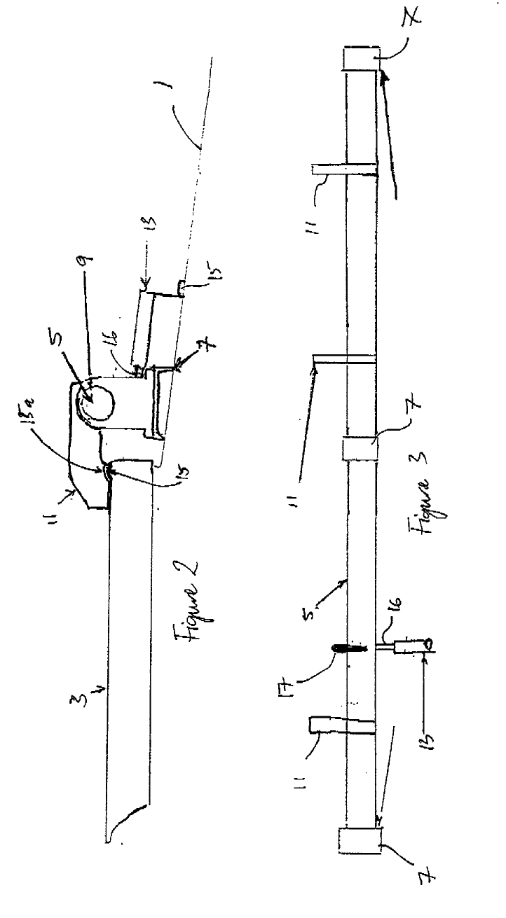

FIG. 2 shows the securing mechanism in more detail;

FIG. 3 is a further view of the securing mechanism;

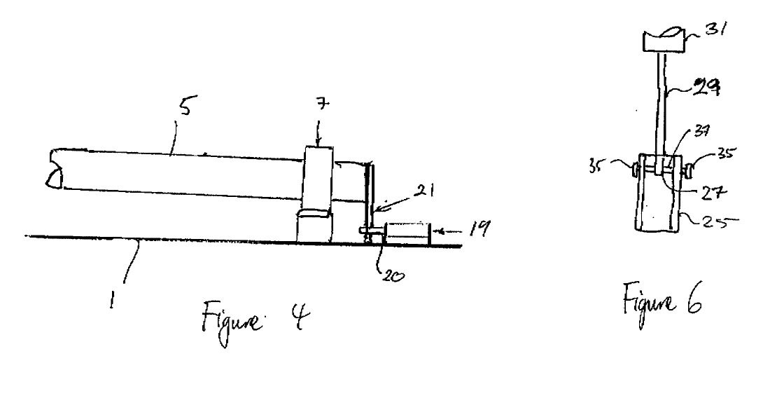

FIG. 4 shows the manner in which the rod of the securing mechanism may be locked;

FIG. 5 shows the lid opening mechanism; and

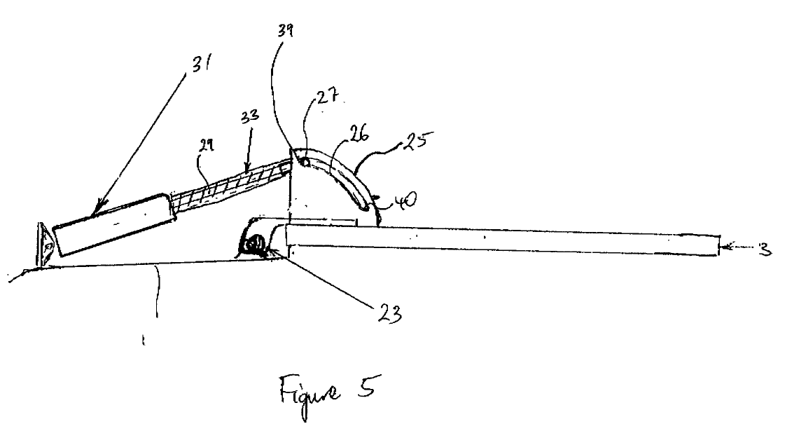

FIG. 6 is a top view of the moon cam of the opening mechanism;

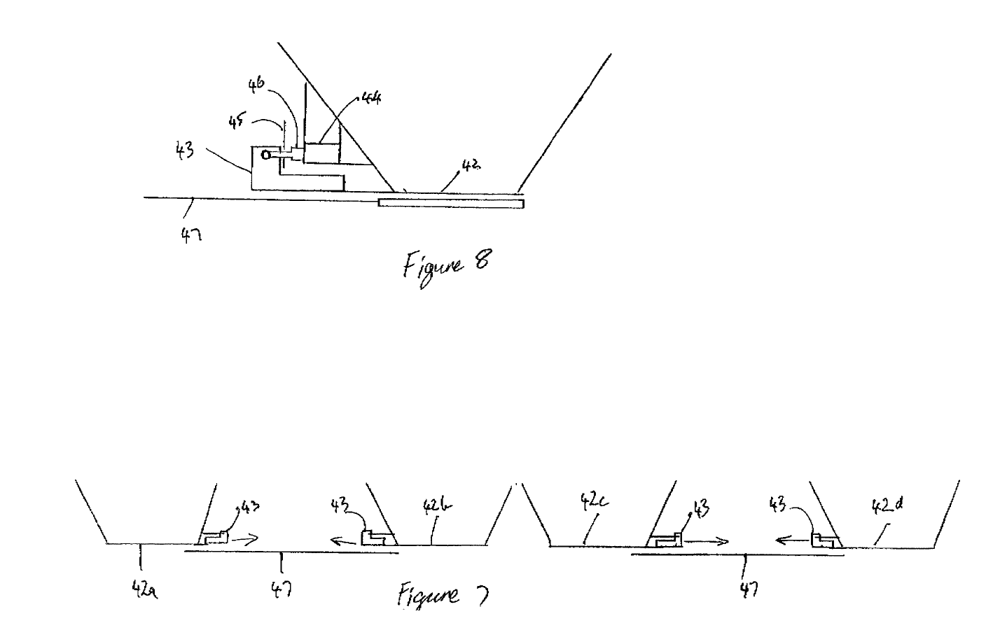

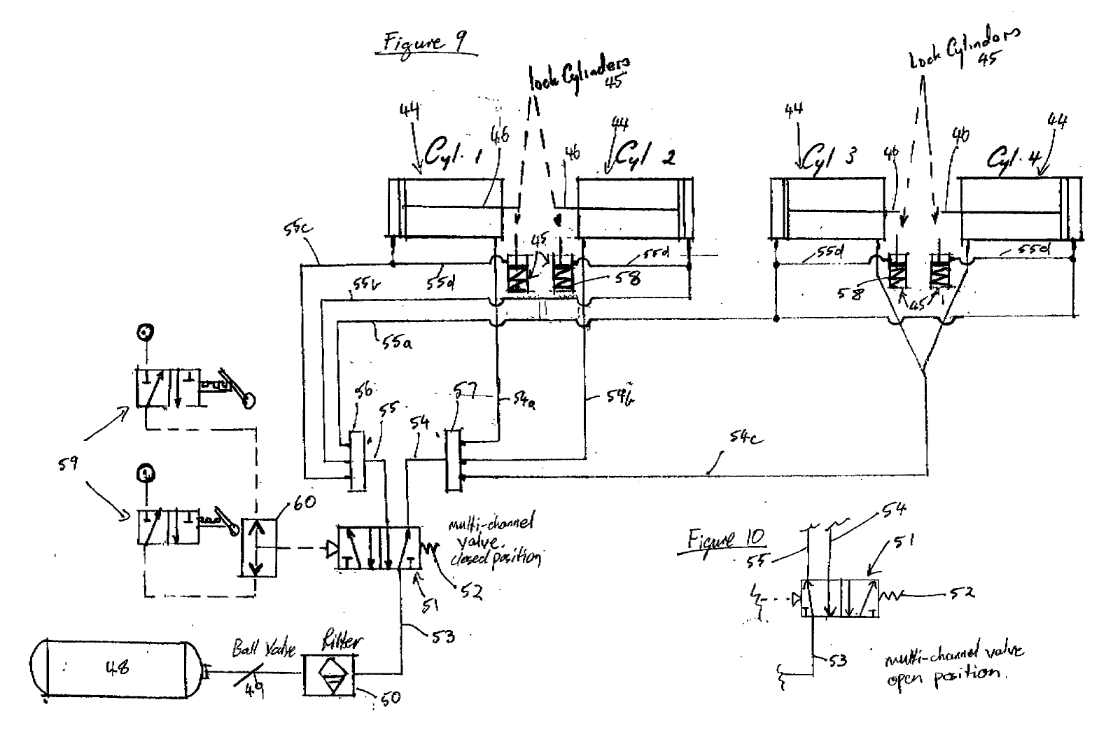

FIG. 7 is a side view of slidable doors with a door opening apparatus fitted to a rail wagon;

FIG. 8 shows the door opening apparatus in more detail;

FIG. 9 is a piping and instrumentation diagram for supplying air to the door opening apparatus; and

FIG. 10 shows a multi-channel valve in an open position.

With reference to the FIGS, the rail wagon has six lids 3a to 3f and four doors 41a to 41d. In the preferred embodiment, the six lids are subdivided into two sets, namely a first set of lids 3a, 3b and 3c and a second set, 3d, 3e and 3f. Each set of lids have an associated pairs of doors. Furthermore, each door has a door opening/closing apparatus and each set of lids has separate securing and opening/closing apparatus. It will be apparent that in the preferred embodiment, the lid securing and opening/closing apparatus is fitted to a rail wagon and that the lids are opened in order to allow wheat or other grain to be poured into the wagon. When the lids are closed, they can then be secured to prevent the load from becoming contaminated, for example, by rain blown under the lids 3. Once the wagon has transported the wheat to its desired destination, the door opening apparatus can open the doors so that the wheat is discharged from the wagon.

Referring to FIGS. 1 to 4, the lid securing apparatus has a rod 5 rotatably mounted to the wagon 5 by means of three brackets 7 each having a roller bearing 9 so that the rod 5 may rotate relative to the bracket and hence, relative to the wagon.

Three arms 11 are mounted to the rod. When the lid 3 is in the closed position and the securing apparatus is being used to secure the lid in position the arms 11 bear on the upper surface of the lid to secure and hold the lid in the closed position. A notch 15a in each arm 11 corresponds to a protrusion 15 carried by the lid 3 to prevent any horizontal movement of the lid 3 relative to the arm 11.

In order to open the lid 3 it is necessary to rotate the rod 9 to thereby move the arms 11 away from the lid 3 to permit movement of the lid. To achieve this, a rotation means is provided in the form of a rod rotating cylinder 13 which is mounted to the rail wagon 1 by bracket 15 and has a piston 16 which operably mounted to the rod 5 by means of a rod lever 17. As the piston 16 of the rotation cylinder 13 extends, acts on lever 17 and causing rod 5 to rotate, and rotating the arms 11 away from the lids 3. The rotation cylinder 13 is pneumatic and is coupled to the air reservoir of the wagon. This means that no separate power supply is required to drive the cylinder 11. To prevent the rod 5 from rotating due to, for example, air acting on the arms or a rough track, locking means is provided for preventing the rod from being rotated when the arms 11 are securing the lids 3 in the closed position. In the preferred embodiment, locking means is provided at each end of each rod in the form of a locking lever 21 and a locking cylinder 19. When the lids 3 are secured in the closed position the locking lever 21 abuts the piston 20 of locking cylinder 19. The locking cylinder 19 is operable to withdraw the piston 20 from a blocking position to a non blocking position in which the lever 21 and hence the rod may rotate freely.

Once the arms have been rotated away from the position which they secure the lid in the closed position, the lids 3 may be opened by means of the lid opening apparatus. The lids 3 are mounted to the rail wagon by hinges 23. A moon cam 25 is provided on one of the three lids. The other two lids are connected to this lid. In the preferred embodiment, the moon cam 25 is mounted to the central lid 3b or 3e of the respective sets of lids. The free end 27 of the piston 29 of opening cylinder 31 is mounted to the moon cam 25 so that it can move within a pair of arcuate cut-out sections 26 located on either side of the moon cam 25. Specifically, the free end 27 is attached to cross piece 37 which extends through both arcuate cut-out sections 26 and is held in place by means of a pair of nuts 35. The arc length of the arcuate cut-out section is approximately 70°. To open the lid 3, the opening cylinder 31 is operated to retract piston 33. The cross piece 37 mounted to the free end 27 of the piston 29 abuts the end 39 of the cut-out section nearest the cylinder 31 so that as the piston 29 is retracted by the cylinder, it pulls the lid up so that it rotates around hinge 23 until the lid reaches a point at which gravity causes further opening of the lid 3. At this point, the cut-out section 26 of the cam 25 allows the cam to move relative to the free end through the arc length of the cut-out section so that the lid moves to a fully opened position. The free end 26 of the piston moves through an arc which is slightly smaller than the arc length of the cut-out section 27 due to the diameter of the cross piece 39. The arc length of 70° of the cut-out section 26 allows the lid 3 to rotate approximately 160° from the closed position. It will be apparent that the arc length of the cut-out sections may be altered to produce a desired opening angle—i.e. a desired amount of rotation from the closed position.

Again, the opening cylinder 31 is pneumatic and coupled to the air supply of the rail wagon. A dust cover 33 is provided on the piston 29 to prevent dust from fouling the action of the opening cylinder. To close the lid 3, the operation is reversed and the piston 29 is extended at which time it abuts against the end 40 of the arcuate section 26 which is farthest from the cylinder 31. The cross piece 39 pushes against end 40 until such time as gravity takes over and causes further closing of the lid. It will be appreciated that when the free end 27 moves freely within the arcuate cut-out section the opening cylinder piston 29 may not be fully extended and hence, the cross piece 37 will bear on the closer end 39 of the arcuate cut-out section and effectively brake the closing of the lid 3 so that the lid 3 is only fully closed when the piston 29 is fully extended. Once the lid has been closed, it can be secured in the manner described above.

Referring to FIGS. 7 and 8, the sliding door opening apparatus includes: a door 42 slidable mounted to cover an opening in the bottom of a rail wagon; an arm 43; an opening cylinder 44; a locking cylinder 45; and a safety bar 47.

One end of the arm 43 is welded to the slidable door 43 and the other end is pivotably connected to the free end of a piston 46 of the opening cylinder 44, The arm 43 has an elbow so that the opening cylinder 44 can be located above the door 42 and thereby protected from debris when the wagon is in transit.

The locking cylinder 45 consists of a locking piston that can be extended to blockingly engage the piston 46 of the opening cylinder 44.

In order to open the door 42, the locking piston is retracted and the piston 46 of the opening cylinder allowed to move the door 42 into an open position. Referring to FIG. 7, two doors 42a and 42b (associated with lids 3a to 3c) open toward each other shown by the direction of the arrows. A safety obstruction in the form of a bar 47 extending between the two doors 42 prevent a person from standing and been crushed between the doors 42 while being opened.

All five of the cylinders 13, 19, 31, 44 and 45 are linked to the air supply of the wagon 1. The cylinders form an automated system for opening a hinged lid so that wheat can be poured into the wagon and for opening the slidable door to discharge wheat or other grain from the wagon. An operator controls the system at one or more control panels located at the side of the wagon for easy operation. Each cylinder 13, 19 31, 44 and 45 is operated by a switching mechanism and a timing circuit. To open a set of lids, an operator operates a switch or button to switch the system on, the timing circuit for the lid 3 ensures locking cylinder 19 operates for sufficient time in order to withdraw the locking piston 21, whereafter the locking cylinder 19 is turned off and rotation cylinder 19 is turned on to rotate the rod 5 and lift the arms 11 away from the lid 3. The timer then turns off the rotation cylinder 19 and turns on opening cylinder 31 in order to open the lid 3. Wheat can then be poured into the wagon 5. The procedure is reversed when the lid is closed and controlled by the timing circuit accordingly.

Once the wagon hag reached its desired destination, the operator operates a switch or button to turn the system on in order to open the door 42 and discharge the wheat.

More specifically, the door 42 is opened using the air supply of the wagon stored in reservoir 48. With reference to FIG. 9, the reservoir 48 is connected to a multi-channel valve 51 via an air filter 50 and a ball valve 49 for isolating the multichannel valve 51 from the reservoir 48. A pipe line 53 supplies air into the multi-channel valve 51 and two lines 54 and 55 are connected to the opposite side of the valve 51.

Two levers 59, located on opposite sides of the rail wagon 1 can be positioned in an off position, an open position to open the door 42, or a closed position to close the door 42. The levers 59 are coupled to the multi-channel valve 51 via an OR operator 60 so that the doors 42 can be operated by operating one of the levers 49 on a side of the rail wagon 1.

FIG. 9 illustrates the multi-channel valve 51 in a closed position so that air from the air reservoir 48 is conveyed from line 53 to line 54 and air from line 55 is also conveyed into and/or released by valve 51 into the atmosphere. The multi-channel valve 51 is shown as having two chambers, each chamber having two channels and the direction of the arrows shown on the channels indicates the direction of air flow through each channel. The pipe line 54 is connected to an air manifold 57 which is itself connected to three other lines 54a to c for distributing the air in line 54 to these lines, or for feeding the air in lines 54a to c into line 54. Similarly, line 55 is connected to an air manifold 56 which is itself connected to three other lines 55a to c so that air in said line 55 can be distributed into lines 55a to c, or air in lines 55a to c can be fed into line 55.

With the lever 59 and thus the multi-channel valve 51 in a closed position, air from the air reservoir 48 is distributed between lines 54a to c which convey the air into the piston shaft side of the opening cylinders 44 so as to retract the pistons 46 and thus close the door 42. Further, air from the piston head side of the opening cylinders 44 is conveyed through lines 55a to c and fed and/or release to the atmosphere by the multi-channel valve 51 via air manifold 56 and line 55. In addition, bleed lines 55d branching from lines 55a to c convey air from the piston head side of each locking cylinder 45 so that a biasing spring means 58 extends the locking piston of the locking cylinder into blocking engagement with opening piston 46 of the opening cylinder 44, thereby preventing the door 42 from opening.

FIG. 10 illustrates the multi-channel valve 51 in an open position. In this position, air from the air reservoir 48 is conveyed through line 55 via the valve 51 and distributed into lines 55a to c which supply the air into the piston head side of the opening cylinders 44, thereby extending the pistons 46 of the opening cylinders 44 and opening the door 42. The bleed lines 55d convey air into the piston shaft side of the locking cylinder 45, thereby retracting the locking piston into a non-blocking position with the piston 46 of the opening cylinder 44.

As can be seen in FIGS. 9 and 10, a spring 52 biases the multi-channel valve 51 toward a closed position so that door 42 can only be opened by moving the lever 49 (from an off or closed position) to an open position.

The system and apparatus according to the present invention can be fitted to new or existing rail wagons.

Various modifications which may be made to the foregoing apparatus will be apparent to persons skilled in the art and may be made without departing from the scope of the invention described herein.

The claims defining the invention are as follows:

1. An apparatus for securing a hinged lid which covers an opening in the top of a rail wagon when in a closed position, said apparatus including:
a rod rotatably mounted to the top of the wagon along at least part of a free side of said lid opposite or adjacent a hinged side of said lid;
an arm mounted to said rod, said arm bearing on said lid to secure said lid in said closed position; and
rotation means for rotating said rod, wherein said rotation means is operable to rotate said rod to thereby rotate said arm away from said lid whereafter said lid may be opened.

2. The apparatus according to claim 1, wherein said rotation means is a rotation cylinder mounted to said wagon and having a piston mounted to said rod so that reciprocal motion of said piston causes rotation of said rod.

3. The apparatus according to claim 2, wherein said cylinder is an pneumatic cylinder.

4. The apparatus according to claim 3, wherein said pneumatic cylinder is coupled to an air reservoir of said wagon.

5. The apparatus according to claim 1, further including a lid opening cylinder having a lid opening cylinder piston connected to said lid for opening said lid.

6. The apparatus according to claim 5, wherein said lid opening cylinder piston is connected to said lid by means of a moon cam, whereby said lid may be rotated around said hinges more than 120° from said secured position.

7. The apparatus according to claim 1, including a plurality of spaced apart arms mounted to said rod.

8. The apparatus according to claim 1, wherein said arm has a notch on an underside thereof adapted to receive a protrusion carried by said lid when securing said lid in said closed position.

9. The apparatus according to claim 1, further including locking means for locking said rod so as to prevent it from being rotated when said arm is securing said lid in said closed position.

10. The apparatus according to claim 8, wherein said locking means includes a locking lever which is prevented from moving by a locking piston of a locking cylinder in blocking engagement with said locking lever when in a locked position, whereby reciprocal movement of said locking piston moves said piston from said blocking position to a non-blocking position in which said lever and said rod are free to rotate.

11. An apparatus for opening a hinged lid from a closed position in which said lid covers an opening in a top of a rail wagon, said apparatus including:
a cam attached to said lid, said cam having an cut-out section; and
an opening cylinder having a piston, the free end of the piston being mounted to the cam so that it can move within the cut-out section of said cam, the opening cylinder being operable to open said lid, during initial opening of the lid, the free end of the piston abutting the end of the cut-out section nearest the cylinder whereby operation of the cylinder pulls the lid up so that it rotates around the hinge until said lid reaches a point at which gravity causes further opening of said lid, whereafter said cut-out section of said cam allows said cam to move relative to said free end to a fully opened position.

12. The apparatus according to claim 11, wherein said cut-out section is shaped so that said lid can rotate more than 120° from the closed position.

13. The apparatus according to claim 11, wherein said cut-out section is shaped so that said lid can rotate more than 150° preferably approximately 160°.

14. The apparatus according to claim 12, wherein said cut-out section is arcuate.

15. The apparatus according to claim 14, wherein said arcuate out-out section has an arc length of greater than 50°.

16. The apparatus according to claim 14, wherein said arcuate cut-out section has an arc length of a approximately 70°.

17. The apparatus according to claim 12, wherein said opening cylinder is a pneumatic cylinder.

18. The apparatus according to claim 17, wherein said opening cylinder is coupled to an air reservoir of said wagon.

19. The apparatus according to claim 11, wherein two or more lids are connected, whereby said opening cylinder is operable to open two or more lids.

20. The apparatus according to claim 19, wherein said opening cylinder is also operable to return said lid to said closed position.

21. An Apparatus for opening a hinged lid from a closed position and securing said hinged lid in said closed position in which said lid covers an opening in a top of a rail wagon,
said apparatus including:
a rod rotatable mounted to the top of the wagon along at least part of a free side of said lid opposite or adjacent a hinged side of said lid;
an arm mounted to said rod, said arm bearing on said lid to secure said lid in said closed position;
rotation means for rotating said rod, wherein said rotation means is operable to rotate said rod to thereby rotate said arm away from said lid whereafter said lid may be opened;
a cam attached to said lid, said cam having a cut-out section; and
an opening cylinder having a piston, the free end of the piston being mounted to the cam so that it can move within the cut-out section of said cam, the opening cylinder being operable to open said lid, during initial opening of the lid, the free end of the piston abutting the end of the cut-out section nearest the cylinder whereby operation of the cylinder pulls the lid up so that it rotates around the hinge until said lid reaches a point at which gravity causes further opening of said lid, whereafter said cut-out section of said cam allows said cam to move relative to said free end to a fully opened position.

22. The apparatus according to claim 21, wherein said rotation means is a rotation cylinder mounted to said wagon and having a piston mounted to said rod so that reciprocal motion of said piston causes rotation of said rod.

23. The apparatus according to claim 22, wherein said rotating cylinder and opening cylinder are pneumatic cylinders.

24. The apparatus according to claim 22, wherein said rotating cylinder and opening cylinder are coupled to an air reservoir of said wagon.

25. An apparatus for opening a door slidably mounted to cover an opening at a bottom of a rail wagon when said door is in a closed position, the apparatus including,
an opening cylinder having a piston, the free end of the piston being connected to the door so that operation of the opening cylinder can slide the door from said closed position to an open position.

26. The apparatus according to claim 25, further including an arm interconnecting the door and the free end of the piston.

27. The apparatus according to claim 26, further including locking means for locking said piston so as to prevent the door from being opened when in said closed position.

28. The apparatus according to claim 27, wherein said locking means includes a locking cylinder having a locking piston in blocking engagement with said piston of the opening cylinder when in a locked position, and operation of the locking cylinder moves said locking piston from said blocking engagement to a non-blocking position in which said piston of the opening cylinder is free to reciprocate.

29. The apparatus according to claim 28, wherein said locking cylinder and opening cylinder are pneumatic cylinders.

30. The apparatus according to claim 29, wherein said locking cylinder and opening cylinder are coupled to an air reservoir of said wagons.

31. The apparatus according to claim 25, wherein adjacent doors of the rail wagon slide toward each other while being opened.

32. The apparatus according to claim 31, wherein a safety obstruction for shielding space between the opening apparatus of said adjacent doors prevents injury being caused to a person while said adjacent doors are being opened.

33. An automatic system for opening a hinged lid and a slidable door from a closed position in which said hinged lid covers an opening in a top of a rail wagon and said door covers an opening located at a bottom of the rail wagon, said system including:
(a) a first apparatus having a first opening cylinder with a piston, the free end of the first piston being connected to said door; and
(c) a second apparatus including:
a cam attached to said lid, said cam having a cut-out section; and
an opening cylinder having a piston, the free end of the piston being mounted to the cam so that it can move within the cut out section of said cam; and
the system being characterised in that during initial opening of the lid, the free end of the piston abuts the end of the cut-out section nearest the opening cylinder such that operation of the cylinder pulls the lid up so that it rotates about a hinge until said lid reaches a point at which gravity causes further opening of said lid, whereafter said cut-out section of said cam allows said cam to move relative to said free end of the opening piston so that the lid moves to a fully opened position, and the system being further characterised in that said first and second opening cylinders are operable to open said door and lid respectively.

34. The system according to claim 33, wherein the first and second opening cylinders are pneumatic cylinders.

35. The system according to claim 34, wherein said first and second opening cylinders are coupled to an air reservoir of said wagon.

36. The system according to claim 35, including a control whereby an operator can operate the control to choose whether to open the door or lid, and air from the air reservoir can be supplied to either the first or second cylinder in accordance with the operator's choice.

37. The system according to claim 35, further including a third apparatus for securing a hinged lid which covers an opening in the top of a rail wagon when in a closed position, said third apparatus including:
a rod rotatable mounted to the top of the wagon along at least part of a free side of said lid opposite or adjacent a hinged side of said lid;
an arm mounted to said rod, said arm bearing on said lid to secure said lid in said closed position; and
rotation means for rotating said rod, wherein said rotation means is operable to rotate said rod to thereby rotate said arm away from said lid whereafter said lid may be opened.
